(19) United States
(12) Patent Application Publication
(10) Pub. No.: US 2007/0136227 A1
(43) Pub. Date: Jun. 14, 2007

(54) Location-based searches by measuring location-based clickthrough measurements using implicit location

(75) Inventor: Maarten Wegdam, Enschede (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/301,425

(22) Filed: Dec. 13, 2005

(51) Int. Cl. G06F 17/30

(52) U.S. Cl. 707/1

(57) ABSTRACT

A location-based search engine is improved by using a ranking algorithm that combines clickthrough measurements with implicit user location. The location is passed to the search, without requiring explicit user input of the location.

### FIELD OF THE INVENTION

The present invention relates generally to the fields of searching and networking and, in particular, relates to improving location-based searches in location-based networks.

### BACKGROUND OF THE INVENTION

Clickthrough measurement is a well-known parameter for search algorithms. This means that a search engine measures which of the results someone has selected for a particular search and uses this measurement to promote (or drop) pages that are (or are not) attracting clicks in consecutive searches.

A more recent development for search engines is location-based searches, where the user indicates a location in the query (typically which city or region) and the location is used in the ranking algorithm. This requires the search engine to know which webpages are relevant for particular locations, which is currently done by analyzing the web pages for location-specific information, combined with provisioning this data through existing databases, such as yellow pages databases and explicit provisioning interfaces. For example, Google Local provides point-of-interest searches that require explicit location, i.e., manual user input. Having the user do this explicitly is too intrusive for the user, i.e., user unfriendly. Thus, there is a need to do local searches automatically in a user friendly way, without explicit user input.

### SUMMARY

Various deficiencies of the prior art are addressed by various exemplary embodiments of the present invention of improving location-based searches by measuring location-based clickthrough measurements using implicit location.

One embodiment is a method for providing location information. A request is received for a location-based service. The implicit location of a user is determined automatically and provided. Another embodiment is a computer readable medium storing instructions for performing this method.

Another embodiment is a system for providing location information, including a location provider and an application program interface (API) and a location provider. The API receives a request for a location-based service and the location provider automatically provides the implicit location of a user.

### BRIEF DESCRIPTION OF THE DRAWINGS

The teachings of the present invention can be readily understood by considering the following detailed description in conjunction with the accompanying drawings, in which:

FIG. 1 is a block diagram showing an exemplary embodiment of a location-based search;

FIG. 2 is a block diagram showing another exemplary embodiment of a location-based search;

FIG. 3 is a block diagram showing yet another exemplary embodiment of a location-based search; and

FIG. 4 is a high level block diagram showing a computer. To facilitate understanding, identical reference numerals have been used, where possible, to designate identical elements that are common to the figures.

### DETAILED DESCRIPTION OF THE INVENTION

The invention will be primarily described within the general context of embodiments of improving location-based searches by measuring location-based clickthrough measurements using implicit location. However, those skilled in the art and informed by the teachings herein will realize that the invention is applicable generally, because implicit location is useful for a wide range of services, such as commerce, emergency services, security, law enforcement, and many location-based services and other services would benefit from implicit location.

One embodiment is a location-based search engine that is improved by using a ranking algorithm that combines clickthrough measurements with implicit user location. The implicit user location is passed to the search, without requiring the user to explicitly input it.

A ranking algorithm for any type of search is extended by using the location of the user and clickthrough measurements based on the user location rather than just popularity. This location can be implicit, i.e., without explicit user input. The location can be determined by a wide variety of methods, varying from using the IP address as an indication to more explicit methods such as global positioning system (GPS) and network-based location determination. Depending on the method used, the location will have a different accuracy. The ranking algorithm may use the accuracy in which it receives the location, but also may choose to use the location with wider accuracy. For example, if the accuracy is 10 meters, then the street, precinct, city, region, state/province, country, and continent can all be considered. This ranking algorithm can take as a parameter that if users from a certain location often select a certain result, that this result is apparently more relevant. For example, suppose there are two people with the identical name, John Smith, one who lives in the U.S. and one who lives in the U.K. Users in the U.K. searching for the homepage of John Smith are more likely to be looking for the U.K. John Smith and users in the U.S. are more likely to be looking for the U.S. John Smith. This statistical relation can be discovered automatically through the proposed location-based clickthrough measurements. Of course, users might search for something for a location different than their current location, but statistically, the current location is an indication for relevance of the results for that location.

Exemplary embodiments of the present invention have many advantages. Combining clickthrough measurements with implicit user location helps to improve ranking algorithms. A location-based search engine that is improved by using a ranking algorithm that combines clickthrough measurements with implicit user location results in more user friendly, location-based searches. Mobile services, voice mail, cell phone service, and location-based services and other kinds of services that implicitly include location can be enhanced. For example, a mobile operator can easily offer a location-based search engine using implicit location, because the location is readily available. Location-based searches are one way to offer a more personalized service or experience to the user.

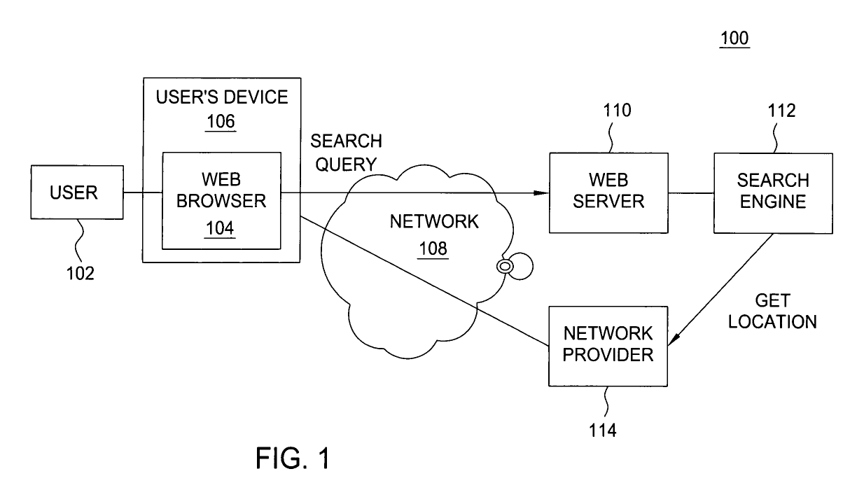

FIGS. 1-3 show exemplary embodiments 100, of location-based searches. There are many ways to provide location-based searches by measuring location-based clickthrough measurements using implicit location of which these figures illustrate only a few. Other embodiments are within the scope of the present invention, of course.

In FIG. 1, the network provider 114 knows the location of the user 102. If a user 102 is using a web browser 110 on a device 106 with a fixed network 108 connection, the network provider 114 typically knows the location of the user's house, for example. The user 102 enters a search query via the web server 110 and the search engine 112. The search engine 112 requests the location of the user 102 from the network provider 114. For a mobile user 102, the network provider 114 typically knows the location of the user 102 with an accuracy of a couple hundred meters based on information about a cell phone, for example.

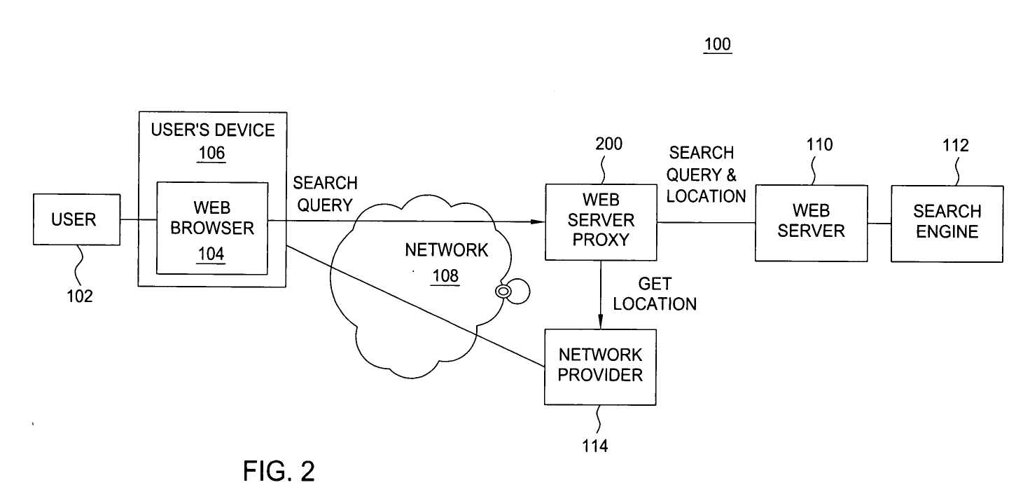

In FIG. 2, a web proxy 200, which can be owned by the network operator, adds the implicit location as another field in the search query request before it is passed to the web server 110. In this example the search engine does need to request the location of the user from the network provider, unlike the example of FIG. 1.

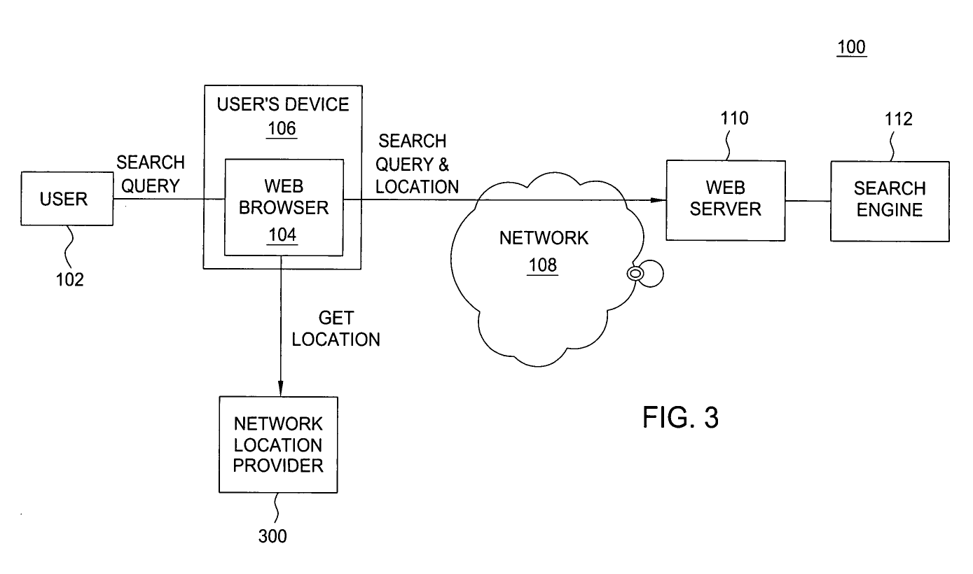

In FIG. 3, the web browser 104 retrieves the location from a network location provider 300 as opposed to the web proxy 200 in the example of FIG. 2. For example, the web browser 104 may have access to an identifier that identifies the user and is associated with the location of the user or web browser 104 may know the current cell identifier of the mobile or wireless network that the user's device 106 is currently using. The web browser 104 uses this cell identifier to access a database that associates cell identifiers with their location. Alternatively, the web browser 104 may have access to a GPS, assisted GPS or a similar location determination mechanism that is part of or connected to the user's device 106. The implicit location is again added to the search query request and passed to the web server 110. The network location provider 300 may be installed on the user's personal computer (PC), laptop, or mobile phone, for example. Thus, there are at least three different ways to provide implicit user location.

In one embodiment a ranking algorithm is enhanced by using the implicit user location. In one embodiment, a local search performed by default so that the user need only indicate when a non-local search is desired. For example, statistics about searches from particular locations may be used to improve rankings. For example, if many other people from New York have been looking for particular information about Central Park, then that information may be important to include in the ranking of search query results of a user from New York asking about Central Park.

In one embodiment, the implicit user location is provided without violating the user's privacy. In one embodiment, the network provider 114 adds a user's cell phone number or other persistent or non-persistent identification of the user to the search query, which is used to get access to the user's location. In one embodiment, a general location with a predetermined accuracy is passed to maintain the privacy of the user, such as a city and state. In one embodiment, the implicit location is passed without any identifier that is linked to the identify of the user.

In one embodiment, a computer program includes a method for determining the implicit location of the user and provides the implicit location to a network provider 114, a search engine 112, a web browser 104, or another computer program or network or system component. Thus, the location provider includes at least one interface. The location of the user may be provided in many forms, such as latitude and longitude, region, zip code and the like. There are various potential sources of the implicit user location, such as GPS, cell phone location, home address, IP address, and the like. There are many uses of the implicit user location, such as improving results from the ranking algorithm in a search engine 112. An implicit user location provider may be part of a larger system, for example, to help mobile operators provide new services that cater to people's lifestyles on current and third-generation (3G) wireless networks. The larger system may include wireless network equipment, middleware, open application program interfaces (APIs), Internet content, mobile Internet developer's kits, software applications, specialized transaction-based based micro-billing solutions, business consulting and professional services, mobile devices, and the like. A location-based service may be provided by a gateway mobile location center (GLMC) in a mobile network where a base station has information about the location of users that can be used implicitly in a search. The base station can pass this information onto various other network elements.

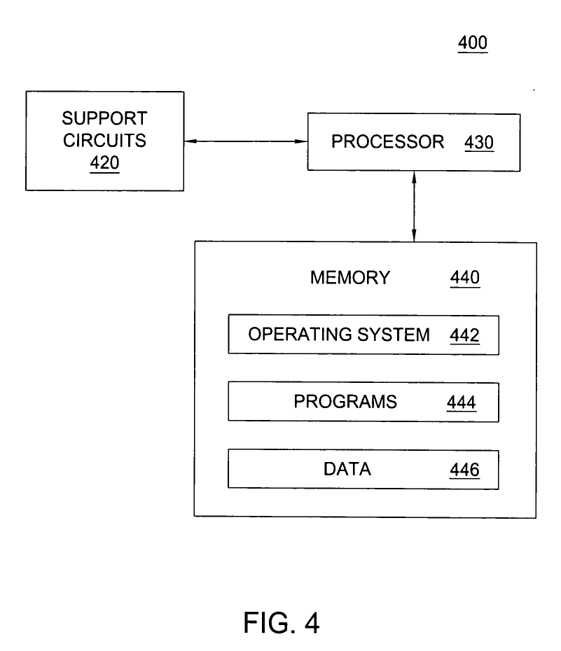

FIG. 4 is a high level block diagram showing a computer. The computer 400 may be employed to implement embodiments of the present invention. The computer 400 comprises a processor 430 as well as memory 440 for storing various programs 444 and data 446. The memory 440 may also store an operating system 442 supporting the programs 444.

The processor 430 cooperates with conventional support circuitry such as power supplies, clock circuits, cache memory and the like as well as circuits that assist in executing the software routines stored in the memory 440. As such, it is contemplated that some of the steps discussed herein as software methods may be implemented within hardware, for example, as circuitry that cooperates with the processor 430 to perform various method steps. The computer 400 also contains input/output (I/O) circuitry that forms an interface between the various functional elements communicating with the computer 400.

Although the computer 400 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for providing location information, comprising:
receiving a request for a location-based service;
determining an implicit location of a user automatically; and
providing the implicit location of the user.

2. The method of claim 1, further comprising:
combining clickthrough measurements with the implicit location of the user.

3. The method of claim 1, wherein the location-based service is a search query.

4. The method of claim 1, wherein the request is from a search engine and the implicit location of the user is provided by a network provider to a web browser.

5. The method of claim 1, wherein the request is from a web server proxy and the implicit location of the user is provided by a network provider to a web browser.

6. The method of claim 1, wherein the request is from a web browser and the implicit location of the user is provided by a network provider to the web browser.

7. The method of claim 1, wherein the implicit location of the user is provided with a degree of accuracy protecting the privacy of the user.

8. A system for providing location information, comprising:
an application program interface (API) to receive a request for a location-based service; and
a location provider to automatically provide an implicit location of a user.

9. The system of claim 8, wherein the location provider combines clickthrough measurements with the implicit location of the user.

10. The system of claim 8, wherein the location-based service is a search query.

11. The system of claim 8, wherein the request is from a search engine and the location provider is a network provider that provides the implicit location of the user to a web browser.

12. The system of claim 8, wherein the request is from a web server proxy and the location provider is a network provider that provides the implicit location of the user to a web browser.

13. The system of claim 8, wherein the request is from a web browser and the location provider is a network provider that provides the implicit location of the user to the web browser.

14. The system of claim 8, wherein the implicit location of the user is provided with a degree of accuracy protecting the privacy of the user.

15. The system of claim 8, wherein the location provider is a base station in a mobile network.

16. A computer readable medium storing instructions for performing a method for providing location information, the method comprising:
receiving a request for a location-based service;
determining an implicit location of a user automatically; and
providing the implicit location of the user.

17. The computer readable medium of claim 16, wherein the request is from a search engine and the implicit location of the user is provided by a network provider to a web browser.

18. The computer readable medium of claim 16, wherein the request is from a web server proxy and the implicit location of the user is provided by a network provider to a web browser.

19. The computer readable medium of claim 16, wherein the request is from a web browser and the implicit location of the user is provided by a network provider to the web browser.

20. The method of claim 1, wherein the implicit location of the user is provided with a degree of accuracy protecting the privacy of the user.
